(19) United States
(12) Patent Application Publication
(10) Pub. No.: US 2016/0037572 A1
(43) Pub. Date: Feb. 4, 2016

(54) METHOD FOR DEVICE TO DEVICE COMMUNICATION BETWEEN TERMINALS AND TERMINAL FOR SUPPORTING SAME

(71) Applicant: Electronics and Telecommunications Research Institute, Daejeon (KR)

(72) Inventors: Choongil YEH, Daejeon (KR); Young Jo KO, Daejeon (KR); Seung Chan BANG, Daejeon (KR)

(21) Appl. No.: 14/810,702

(22) Filed: Jul. 28, 2015

(30) Foreign Application Priority Data
Jul. 29, 2014 (KR) 10-2014-0096778
Sep. 2, 2014 (KR) 10-2014-0116261
Apr. 16, 2015 (KR) 10-2015-0054007

(51) Int. Cl. H04W 76/02; H04W 72/12

(52) U.S. Cl. CPC H04W 76/023; H04W 72/1263; H04W 88/08

(57) ABSTRACT

A first terminal for D2D communication configures a value of a first field that represents continuous transmission of scheduling assignment (SA) information as a first value, when trying to transmit the SA information in a second SA resource pool after a first SA resource pool as well as in the first SA resource pool for the SA. The first terminal transmits the SA information including the first field using the first SA resource included in a first SA resource pool.

### CROSS-REFERENCE TO RELATED APPLICATION

This application claims priority to and the benefit of Korean Patent Application Nos. 10-2014-0096778, 10-2014-0116261, and 10-2015-0054007 filed in the Korean Intellectual Property Office on Jul. 29, 2014, Sep. 2, 2014, and Apr. 16, 2015, the entire contents of which are incorporated herein by reference.

### BACKGROUND OF THE INVENTION

(a) Field of the Invention

The present invention relates to a method for direct communication between terminals and a terminal supporting the same.

(b) Description of the Related Art

In device-to-device (D2D) communication, which is performed between terminals directly, a terminal is able to directly communicate with other terminals without passing through a network (e.g., a base station).

Meanwhile, in order to control (alleviate) collision of resources, congestion, and so on in the D2D communication environment, researches are vigorously progressing on a method for allocating or selecting resources for the D2D communication.

### SUMMARY OF THE INVENTION

The present invention has been made in an effort to provide a method for allocating resources, which has advantages of alleviating a collision of resources, etc.

Further, an object of the present invention is to provide a method in which a terminal is able to randomly select a transmission resource based on sensing. Particularly, an object of the present invention is to provide control that is required for a terminal to randomly select a transmission resource based on sensing.

Another object of the present invention is to provide a method for supporting a Semi-Persistent Scheduling (SPS) type of scheduling.

A further object of the present invention is to provide a method for detecting continuous transmission of Scheduling Assignment (SA) information even though a transmission terminal does not decode the SA information.

Additionally, an object of the present invention is to provide a method for avoiding successive collisions of SA information or device-to-device (D2D) data.

According to an exemplary embodiment of the present invention, a method for device-to-device (D2D) communication in which a first terminal directly communicates with another terminal is provided. The method for D2D communication includes: configuring a value of a first field that indicates continuous transmission of scheduling assignment (SA) information as a first value, when trying to transmit the SA information in a second SA resource pool after a first SA resource pool as well as in the first SA resource pool for the SA; and transmitting the SA information including the first field using a first SA resource included in the first SA resource pool.

A first resource region for the D2D communication may be divided into the first SA resource pool and a first D2D data resource pool for D2D data transmission.

A second resource region after the first resource region may be divided into the second SA resource pool and a second D2D data resource pool after the first D2D data resource pool.

The D2D communication method may further include transmitting the SA information by using a second SA resource that is in the same location as the first SA resource among a plurality of SA resources included in the second SA resource pool.

The D2D communication method may further include configuring the value of the first field as a second value that is different from the first value in case of completing the transmission of the SA information in the first SA resource pool.

The D2D communication method may further include transmitting a first D2D data by using a first D2D data resource among a plurality of D2D data resources included in the first D2D data resource pool.

The SA information that is transmitted using the first SA resource may further include: information of the first D2D data resource; modulation scheme information of the first D2D data; coding scheme information of the first D2D data; and an identifier related to a terminal that is going to receive the first D2D data.

A number of bits of the first field may be one.

The step of transmitting the SA information using the first SA resource may include: monitoring whether the SA information of another terminal is transmitted in the M^{th} (here, M is a natural number of N or less) first SA resource among the N (here, N is a natural number of 2 or more) first SA resources for transmitting the SA information of the first terminal; and repeatedly transmitting the SA information of the first terminal by using the N first SA resources in case the SA information of the another terminal is not transmitted in the M^{th} first SA resource.

The D2D communication method may further: include monitoring whether D2D data of another terminal is transmitted in the M^{th} (here, M is a natural number of N or less) first D2D resource among N (here, N is a natural number of 2 or more) first D2D data resources included in the first D2D data resource pool; and repeatedly transmitting D2D data of the first terminal by using the N first D2D data resources in case the D2D data of the another terminal is not transmitted in the M^{th} first D2D data resource.

According to another exemplary embodiment of the present invention, a method for device-to-device (D2D) communication in which a first terminal directly communicates with another terminal is provided. The D2D communication method includes monitoring first SA information that is transmitted through a first SA resource pool for Scheduling Assignment (SA); determining a first SA resource to be reserved among a plurality of SA resources included in a second SA resource pool after the first SA resource pool when a value of a first field included in the first SA information is a first value; and selecting at least one second SA resource among the rest of the SA resources except for the first SA resource among a plurality of SA resources included in the second SA resource pool.

The location of the first SA resource in the second SA resource pool may be identical to that of a third SA resource in the first SA resource pool.

The third SA resource may be the SA resource in which the first SA information among a plurality of SA resources included in the first SA resource pool is transmitted.

The D2D communication method may further include transmitting second SA information by using the at least one second SA resource.

The step of selecting at least one of the second SA resource may include randomly selecting the at least one second SA resource among the rest of the SA resources except for the first SA resource among a plurality of SA resources included in the second SA resource pool.

The first SA information may be plural.

According to another exemplary embodiment of the present invention, a method for device-to-device (D2D) communication in which the first terminal directly communicates with another terminal is provided. The D2D communication method includes: determining whether a first transmission probability value is configured for the first terminal only; and transmitting first information by using the first transmission probability value among the first transmission probability value and a second transmission probability value for a first cell to which the first terminal belongs in case the first transmission probability value is configured.

The first information may be one of Scheduling Assignment (SA) information for the SA and D2D data.

The first transmission probability value may be greater than the second transmission probability value.

The step of transmitting the first information using the first transmission probability value may include: selecting a first SA resource among a plurality of SA resources included in a SA resource pool for the SA in case the first information is the SA information; and determining whether to transmit the SA information using the first SA resource based on the first transmission probability value.

The D2D communication method may further include transmitting the first information using the second transmission probability value in case the first transmission probability value is not configured.

The second transmission probability value may be commonly applied to all of the terminals that existed in the first cell.

The first transmission probability value may be configured by a base station of the first cell.

### BRIEF DESCRIPTION OF THE DRAWINGS

FIG. 1 is a drawing showing an example of SA information and Medium Access Control (MAC) Protocol Data Unit (PDU) transmission.

FIG. 2 is a drawing showing an example of retransmission of the SA information.

FIG. 3 is a drawing showing a method in which a transmission terminal represents the continuous transmission of SA information according to an exemplary embodiment of the present invention.

FIG. 4 is a drawing showing a method in which a reception terminal is able to recognize the continuous transmission of SA information according to an exemplary embodiment of the present invention even though a reception terminal does not decode the SA information.

FIG. 5 is a drawing showing a method in which a reception terminal is able to recognize the continuous transmission of SA information according to another exemplary embodiment of the present invention even though a reception terminal does not decode the SA information.

FIG. 6 is a drawing illustrating components of the terminal according to an exemplary embodiment of the present invention.

FIG. 7 is a view illustrating a computer system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Similar reference numerals designate similar elements throughout the specification.

Throughout the specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), user equipment (UE), etc., and may include a whole or a part of functions of the MT, MS, AMS, HR-MS, SS, PSS, AT, UE, etc.

Also, a base station (BS) may refer to an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) which performs the role of a base station, a high reliability relay station (HR-RS) which performs the role of a base station, a macro base station, a small base station, etc., and may include a whole or a part of functions of the BS, ABS, HR-BS, nodeB, eNodeB, AP, RAS, BTS, MMR-BS, RS, HR-RS, macro base station, small base station, etc.

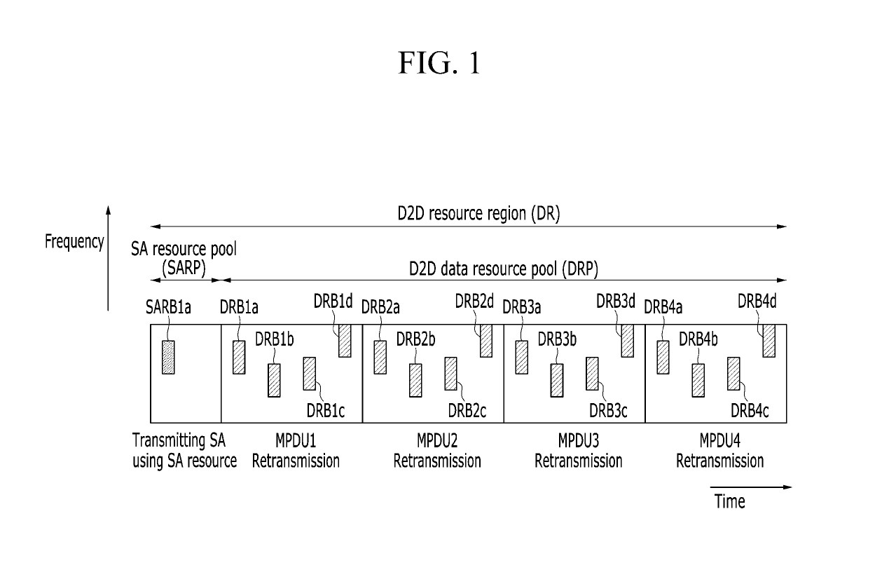

FIG. 1 is a drawing illustrating an example of the Scheduling Assignment (SA) information and Medium Access Control (MAC) Protocol Data Unit (PDU) transmission.

The D2D communication procedure includes a SA procedure and a D2D data transmission procedure.

The D2D resource (DR) region, which is a time-frequency resource region allocated for the D2D communication, is divided into two resource regions, that is, an SA resource pool (SARP) and a D2D data resource pool (DRP) as shown in FIG. 1.

The SA resource pool (SARP) includes a plurality of SA resources, which are time-frequency resources. Each of SA resources may have the same size. One SA resource may include a plurality of Resource Elements (RE).

A terminal randomly selects at least one from a plurality of SA resources, and then transmits the SA information (or SA packet) by using the selected SA resource. For example, in case a terminal selects the SA resource (SARB1a) among a plurality of SA resources, the terminal may transmit the SA information (e.g., control information) through the SA resource (SARB1a) by using the predefined modulation and coding scheme.

In particular, in case a terminal is going to transmit the D2D data, the terminal may transmit the control information that is included in the SA information by using the SA resource (SARB1a). The control information of SA information may include the location information of the D2D data resource that the terminal itself uses for transmitting the D2D data among a plurality of D2D data resources that are included in the D2D data resource pool (DRP). Here, one D2D data resource may include a plurality of REs. Additionally, the control information of SA information may include a transmitting/receiving parameter (e.g., a modulation scheme of D2D data, a coding scheme of D2D data, etc.) that is required for another terminal to receive the D2D data that the terminal itself transmits. Additionally, the control information of SA information may include a terminal identifier (ID). The terminal ID that is included in the control information of SA information may be the ID relevant to the terminal that is going to receive the D2D data. Here, the ID that is related to a reception terminal may be a broadcast ID for broadcasting, a group ID for groupcasting with regard to the D2D communication group where the reception terminal is included, or a unicast ID for unicasting with regard to the reception terminal.

Meanwhile, the terminal may schedule a plurality of MAC PDU transmissions through the transmission of SA information once. Additionally, the terminal may retransmit each MAC PDU several times in order to improve the reception performance and link budget. FIG. 1, for convenience of description, illustrates that the terminal transmits X (e.g., 4) MAC PDUs (MPDU1 to MPDU4) by transmitting SA information once, but each MAC PDU (MPDU1 to MPDU4) is retransmitted Y times (e.g., 4 times). Particularly, the terminal in FIG. 1, transmits one SA information including the location information of the D2D data resource where each MAC PDU (MPDU1 to MPDU4) is transmitted by using one SA resource (SARB1a) among a plurality of SA resources included in the SA resource pool (SARP). The terminal retransmits MAC PDU (MPDU1) four times by using 4 D2D data resources (DRB1a to DRB1d) among a plurality of D2D data resources included in the D2D data resource pool (DRP), and retransmits MAC PDU (MPDU2) four times by using another 4 D2D data resources (DRB2a to DRB2d). The terminal retransmits MAC PDU (MPDU3) four times by using another 4 D2D data resources (DRB3a to DRB3d), and retransmits MAC PDU (MPDU4) four times by using another 4 D2D data resources (DRB4a to DRB4d).

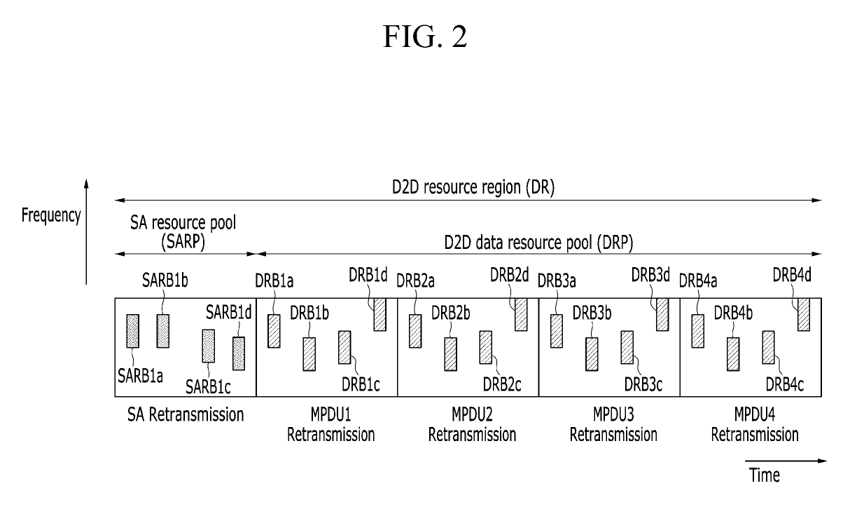

FIG. 2 is a drawing illustrating an example of retransmission of the SA information.

As the retransmission of the D2D data shown in FIG. 1, the SA information may be retransmitted. FIG. 2, for convenience of explanation, illustrates that the terminal retransmits the SA information four times. Particularly in FIG. 2, the terminal may retransmit the SA information (e.g., the same SA information) four times by using 4 SA resources (SARB1a to SARB1d) among a plurality of SA resources included in the SA resource pool (SARP).

Meanwhile, terminals always monitor the SA resource pool (SARP), and decode the transmitted SA resource (SA information). A reception terminal decodes the SA resource (SA information) so that it checks the terminal ID. In case the terminal ID, which is included in the SA information, relates to the reception terminal itself, the reception terminal determines the D2D data resource, which is decoded by the reception terminal itself among a plurality of D2D data resources included the D2D data resource pool (DR), by using the location information of the D2D data resource included in the SA information. The reception terminal decodes the D2D data that is transmitted through the determined D2D data resource by using a transmitting/receiving parameter (e.g., a modulation scheme, a coding scheme, etc.). Meanwhile, such a method corresponds to a dynamic scheduling method that is not basically necessary for sensing.

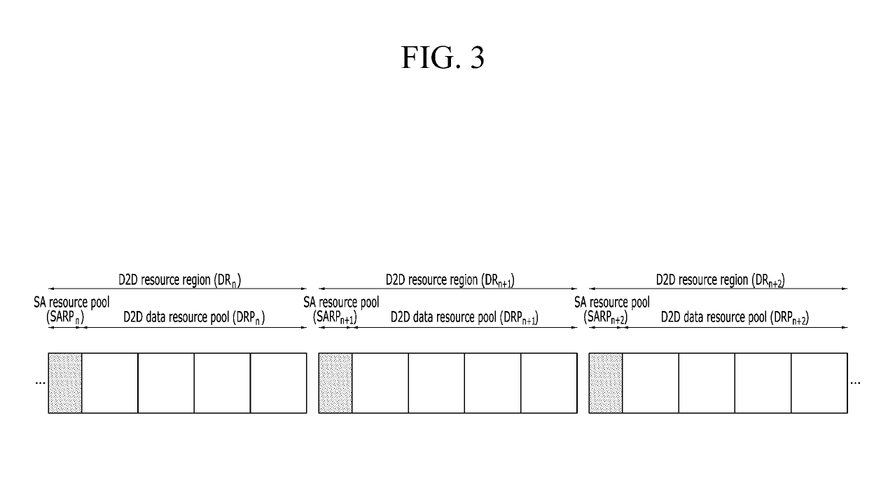

With reference to FIG. 3, a method for supporting a terminal to select a transmission resource randomly and a method for supporting a Semi-Persistent Scheduling (SPS) type of scheduling are described.

FIG. 3 is a drawing illustrating a method in which a transmission terminal indicates the continuous transmission of SA information, according to an exemplary embodiment of the present invention. FIG. 3 illustrates three D2D resource regions (DRₙ to DRₙ₊₂) among a plurality of D2D resource regions. The n^{th} D2D resource region (DRₙ) is divided into an n^{th} SA resource pool (SARPₙ) and an n^{th} D2D data resource pool (DRPₙ). The n+1^{th} D2D resource region (DRₙ₊₁) is divided into an n+1^{th} SA resource pool (SARPₙ₊₁) and an n+1^{th} D2D data resource pool (DRPₙ₊₁). The n+2^{th} D2D resource region (DRₙ₊₂) is divided into an n+2^{th} SA resource pool (SARPₙ₊₂) and an n+2^{th} D2D data resource pool (DRPₙ₊₂).

In order for a terminal to use sensing-based random resource selection, the n^{th} SA resource pool (SARPₙ) and the n+1^{th} SA resource pool (SARPₙ₊₁) are associated.

First, a procedure for the sensing-based random resource selection is described.

The SA information may include a linkage field (L-field). Here, the number of bits of the L-field may be one, and may represent the continuous transmission of SA information. That is, the L-field may represent a correlation between the continuous two transmissions of SA information. Particularly, in case a transmission terminal is going to transmit the SA information continuously, the transmission terminal transmits the SA information using the first SA resource among a plurality of SA resources included in the current SA resource pool (i.e., an n^{th} SA resource pool (SARPₙ)), and transmit the SA information using the second SA resource that is in the same location as the first SA resource among a plurality of SA resources included in the next SA resource pool (i.e., an n+1^{th} SA resource pool (SARPₙ₊₁)). The first SA resource and the second SA resource may be one or more. More particularly, in case the transmission terminal is going to transmit the SA information in the n+1^{th} SA resource pool (SARPₙ₊₁) as well as the n^{th} SA resource pool (SARPₙ), the L-field of the SA information which is going to be transmitted in the n^{th} SA resource pool (SARPₙ) may be set to be 1. The transmission terminal transmits the SA information including the L-field having a value of 1 by using the first SA resource of the n^{th} SA resource pool (SARPₙ), so that it may reserve the second SA resource that is in the same location as the first SA resource among a plurality of SA resources included in the n+1^{th} SA resource pool (SARPₙ₊₁). The transmission terminal may transmit the SA information by using the second SA resource that is reserved in the n+1^{th} SA resource pool (SARPₙ₊₁).

Meanwhile, in case the transmission terminal is not going to perform the continuous transmission of SA information (e.g., the SA information is not transmitted in the n^{th} SA resource pool (SARPₙ), nor transmitted in the n+1^{th} SA resource pool (SARPₙ₊₁)), the L-field of the SA information that is going to be transmitted in the n^{th} SA resource pool (SARPₙ) may be set to be 0. The transmission terminal transmits the SA information including the L-field having a value of 0 by using the first SA resource of the n^{th} SA resource pool (SARPₙ), so that it releases the second SA resource of the n+1^{th} SA resource pool (SARPₙ₊₁) and does not transmit the SA information using the second SA resource of the n+1^{th} SA resource pool (SARPₙ₊₁).

Meanwhile, in case another terminal is going to transmit the SA information in the n+1^{th} SA resource pool (SARPₙ₊₁), in order to distinguish the SA resource of a non-busy state (an idle state), the terminal receives (or monitors) the SA information in the n^{th} SA resource pool (SARPₙ). The received SA information may be one or more. The terminal that receives the SA information in the n^{th} SA resource pool (SARPₙ) checks the L-field value of the SA information received, to thereby determine the SA resource that is going to be released among a plurality of SA resources included in the n+1^{th} SA resource pool (SARPₙ₊₁) or the SA resource of a non-busy state. Particularly, the terminal may determine the SA resource of a non-busy state among the SA resources of the n^{th} SA resource pool (SARPₙ), which is not currently used, to be in a non-busy state in the n+1^{th} SA resource pool (SARPₙ₊₁). When the terminal receives the SA information including the L-field having a value in the n^{th} SA resource pool (SARPₙ), it determines that a specific SA resource (which is in the same location as the SA resource where the corresponding SA information is transmitted) is reserved among a plurality of SA resources of the n+1^{th} SA resource pool (SARPₙ₊₁). The terminal randomly selects at least one among the SA resources that are determined to be in a non-busy state or to be released. That is, the terminal may randomly select at least one among the rest of the SA resources except for the SA resource pre-booked among a plurality of SA resources included in the n+1^{th} SA resource pool (SARPₙ₊₁). In addition, the terminal transmits the SA information using the SA resource selected among the SA resources of the n+1^{th} SA resource pool (SARPₙ₊₁).

Next, a method for supporting a, SPS type of scheduling will be described.

As described in FIG. 1, in order to schedule one MAC PDU transmission or a plurality of MAC PDU transmissions (for example, scheduling for the D2D data resource), one SA information transmission is necessary in advance, so that it may be classified as a dynamic scheduling method.

Meanwhile, transmissions of PTT (Push To Talk), still image (still picture) and motion picture (dynamic picture or moving picture) are important services in Public Safety (PS). In order to provide such services, it is more effective to allocate resources by using an SPS type of scheduling rather than a dynamic scheduling method.

In case the SA information includes the L-field, the transmission terminal may use the resource by continuously booking (occupying). Particularly, in case the transmission terminal needs to transmit the D2D data continuously, it may set the L-field of SA information to be 1 until the continuous transmission of the D2D data is completed. Through this, the transmission terminal may continuously use a specific SA resource of the SA resource pool (SARPₙ to SARPₙ₊ₘ). For example, the transmission terminal transmits the SA information including the L-field having a value of 1 by using the first SA resource of the n^{th} SA resource pool (SARPₙ), to thereby book the second SA resource (which is in the same location with the first SA resource) of the n+1^{th} SA resource pool (SARPₙ₊₁). The transmission terminal transmits the second SA resource (which is in the same location as the first SA resource) of the n+1^{th} SA resource pool (SARPₙ₊₁) including the L-field having a value of 1, to thereby book the third SA resource (which is in the same location as the first SA resource) of the n+2^{th} SA resource pool (SARPₙ₊₂). Finally, the terminal may obtain a merit that is provided by the SPS.

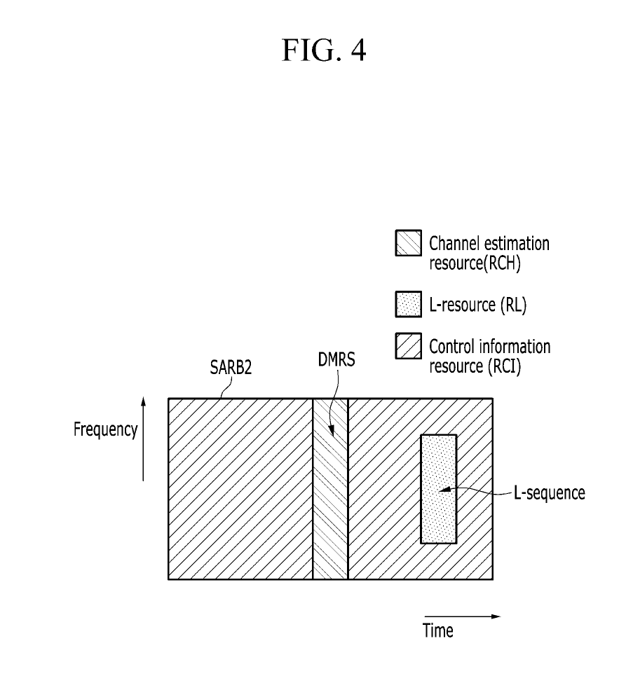

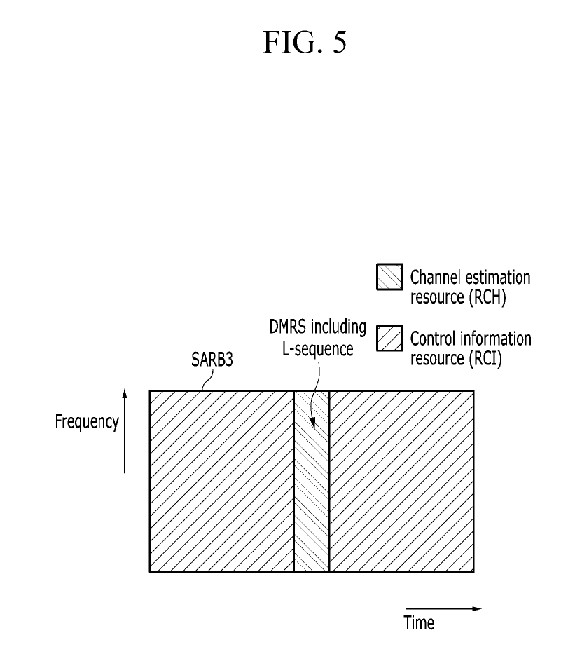

Meanwhile, in case the transmission terminal represents continuity (relationship) between two SA information transmissions using the L-field included in the SA information, the reception terminal may know the L-field value from certainly decoding the SA information transmitted. Referring to FIG. 4 and FIG. 5, a method to know the continuous transmission of SA information (i.e., the way how to represent the continuous transmission of SA information by using physical signals) will be described even though the reception terminal does not decode the SA information.

FIG. 4, according to an exemplary embodiment of the present invention, is a drawing illustrating the continuous transmission of SA information even though the reception terminal does not decode the SA information.

A sequence (L-sequence) that represents 1 or 0 is predefined. That is, the L-sequence may be used instead of the L-field.

The transmission terminal transmits the L-sequence by using a part (RL) among a plurality of REs included in the SA resource. That is, the transmission terminal may indicate the continuous transmission of SA information using the L-sequence. Specifically, in case the transmission terminal is going to transmit the SA information in the n+1^{th} SA resource pool (SARPₙ₊₁) as well as in the n^{th} SA resource pool (SARPₙ), it may transmit the L-sequence representing 1 by using the L-resource (RL) included in the SA resource (SARB2) among a plurality of SA resources of the n^{th} SA resource pool (SARPₙ). Here, the L-resource (RL) may include a plurality of REs. Further, the transmission terminal may transmit the sequence of Demodulation Reference Signal (MRS) by using a channel estimation resource (RCH) included in the SA resource (SARB2). The channel estimation resource (RCH) may include a plurality of REs. The transmission terminal may transmit control information (e.g., D2D data resource information, transmitting/receiving parameter, terminal ID, and so on) by using a control information resource (RCI) included in the SA resource (SARB2). The control information resource (RCI) may include a plurality of REs. Meanwhile, in case the transmission terminal is not going to perform the continuous transmission of SA information (for example, the SA information is transmitted in the n^{th} SA resource pool (SARPₙ) but the SA information is not transmitted in the n+1^{th} SA resource pool (SARPₙ₊₁)), it may transmit the L-sequence indicating 0 by using the L-resource (RL) included in the SA resource (SARB2) among a plurality of SA resources of the n^{th} SA resource pool (SARPₙ).

The reception terminal may check whether the SA information is continuously transmitted through detection of the L-sequence only for the SA information even though the SA information is not decoded (before the SA information is decoded).

FIG. 5, according to another exemplary embodiment of the present invention, is a drawing illustrating a method in which the continuous transmission of SA information is to be recognized even though the reception terminal does not decode the SA information. A method of FIG. 5 has a difference from that of FIG. 4 in that a DMRS sequence is used instead of a separate L-sequence.

The transmission terminal may indicate the continuous transmission of SA information by using the DMRS sequence for channel estimation. The DMRS sequence may include the L-sequence. To be more specific, in case the transmission terminal is going to transmit the SA information in the n+1^{th} SA resource pool (SARPₙ₊₁) as well as in the n^{th} SA resource pool (SARPₙ), it may transmit the DMRS sequence representing 1 by using the channel estimation resource (RCH) included in the SA resource (SARB3) among a plurality of SA resources of the n^{th} SA resource pool (SARPₙ). The channel estimation resource (RCH) may include a plurality of REs. The transmission terminal may transmit the control information (e.g., D2D data resource information, transmitting/receiving parameter, terminal ID, and so on) by using the control information resource (RCI) included in the SA resource (SARB3). The control information resource (RCI) may include a plurality of REs. Meanwhile, in case the transmission terminal is not going to perform the continuous transmission of SA information (e.g., the SA information is transmitted in the n^{th} SA resource pool (SARPₙ) but the SA information is not transmitted in the n+1^{th} SA resource pool (SARPₙ₊₁)), it may transmit the DMRS sequence indicating 0 by using the channel estimation resource (RCH) included in the SA resource (SARB3) among a plurality of SA resources of the n^{th} SA resource pool (SARPₙ).

The reception terminal may check whether the SA information is continuously transmitted through detection of the DMRS sequence only for the SA information even though the SA information is not decoded (before the SA information is decoded).

Next, a method for avoiding a continuous collision of resources will be described.

In case terminals randomly select SA resources, the terminals may select SA resources of different locations, but may select SA resources of the same location. In case a plurality of terminals select a SA resource of the same location, a collision of resources occurs, and if a plurality of terminals transmit the SA information continuously, the collision of resources may occur sequentially.

In order to prevent such successive collisions of resources, in case the transmission terminal retransmits the SA information k times as shown in FIG. 2, it may select one among the k SA information randomly, cease the retransmission of the SA information in the location of the selected SA resource, and monitor whether another terminal transmits the SA information in the location of the selected SA resource. For example, the transmission terminal may randomly select one among 4 SA resources (SARB1a-SARB1d) for the retransmission of the SA information, and monitor whether the SA information of another terminal is transmitted in the location of the selected SA resource (e.g., SARB1c). If the transmission terminal checks that the SA information of another terminal is transmitted in the location of the selected SA resource (e.g., SARB1c), it recognizes that a collision of resources occurs, ceases the transmission of SA information (or continues transmission of the SA information), and attempts scheduling again. If the transmission terminal checks that the SA information of another terminal is not transmitted in the location of the selected SA resource (e.g., SARB1c), it may continuously perform the retransmission of SA information or the successive transmission of SA information.

Meanwhile, a method to prevent the successive collision of resources described above may be applied for the D2D data retransmission identically or similarly. For example, referring to FIG. 2, the transmission terminal may randomly select one among 4 D2D data resources (DRB1a to DRB1d) for the retransmission of the D2D data, and monitor whether the D2D data of another terminal is transmitted in the location of the selected D2D data resource (e.g., DRB1b). If the transmission terminal determines that the D2D data of another terminal is transmitted in the location of the selected D2D data resource (e.g., DRB1b), it recognizes a collision of resources, ceases the transmission of the D2D data, and attempts scheduling again.

Next, a method for supporting an emergency call (an emergency transmission) or a preferential call (a preferential transmission) will be described.

In case the transmission terminal is going to transmit the SA information, it may transmit the SA information according to cell-specific transmission probability p1 after selecting the SA information in the SA resource pool (SARP). In case a collision occurs due to the increase of terminals, and the performance of terminals is deteriorated, the terminal may make good use of the method. In particular, the base station of a cell may regulate a value of a cell-specific transmission probability p₁. For example, in case the cell-specific transmission probability p₁=1, the terminal selects the SA resource in the SA resource pool (SARP), and then immediately transmits the SA information. For another example, in case the cell-specific transmission probability p₁=0.5, the terminal selects the SA resource in the SA resource pool (SARP), and then transmits the SA information with a 0.5 probability. For example, if the terminal gets an even number as by throwing a die, it transmits the SA information, and if an odd number, the terminal does not transmit the SA information. That is, in case a cell-specific transmission probability p₁=0.5, the probability that the terminal transmits the SA information is 0.5. The cell-specific transmission probability p₁ is commonly applied to all the terminals within the sphere of influence of the corresponding cell.

Together with the cell-specific transmission probability p₁, a UE-specific transmission probability p₂ may be independently set to an individual terminal. The UE-specific transmission probability p₂ may be set to a specific terminal only.

More particularly, the base station of a cell may set a value of cell-specific transmission probability p₁ according to the amount of traffic within the cell. For example, the base station of the cell, in order to alleviate collisions, may set a value of cell-specific transmission probability p₁ for all the terminals within the cell.

The base station of a cell, if necessary (for example, a preferential transmission or, an emergency transmission), may set a value of UE-specific transmission probability p₂ that is applied for an individual terminal. Or, the value of UE-specific transmission probability may be set to a specific terminal in advance in the implementation of a specific terminal. The value of UE-specific transmission probability p₂ may be higher than the value of cell-specific transmission probability p₁.

The specific terminal determines whether the two values of transmission probability p₁ and p₂ are set to itself.

In case the specific terminal has the two values of transmission probability p₁ and p₂, it transmits the SA information by using the UE-specific transmission probability p₂ of the cell-specific transmission probability p₁ and the UE-specific transmission probability p₂. That is, the UE-specific transmission probability p₂ takes precedence over the cell-specific transmission probability p₁. For example, in case two sorts of transmission probability values (p₁=0.5, p₂=1) are set to a specific terminal having a high priority, the specific terminal takes precedence of the SA resource over other terminals within the same cell, and to thereby transmit the SA information. This is because other terminals to which only the value of UE-specific transmission probability (p₁) is configured transmit the SA information with a probability of 0.5, but a specific terminal to which the value of UE-specific transmission probability (p₂) is also configured in addition to the value of UE-specific transmission probability (p₁) may transmit the SA information with a probability of 1. Through this, the priority for supporting the emergency call may be secured. In this way, the UE-specific transmission probability p₂ may be effectively used for supporting the emergency call.

Meanwhile, a specific terminal on which the values of two sorts of transmission probability p₁ and p₂ are set may transmit the D2D data as well as the SA information according to the value of UE-specific transmission probability p₂.

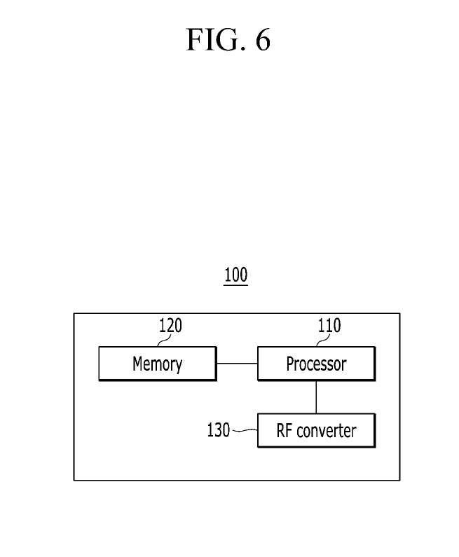

FIG. 6 is a drawing illustrating the configuration of a terminal 100 according to an exemplary embodiment of the present invention.

The terminal 100 include a processor 110, a memory 120, and a Radio Frequency (RF) converter 130.

The processor 110 may be configured in order to embody a procedure, a function, and a method related to the terminal described above.

The memory 120 is connected to the processor 110 and saves a variety of information related to the processor 110.

The RF converter 130 is connected to the processor 110 and transmits or receives the wireless signal. The terminal 100 may have a single antenna or multiple antennas.

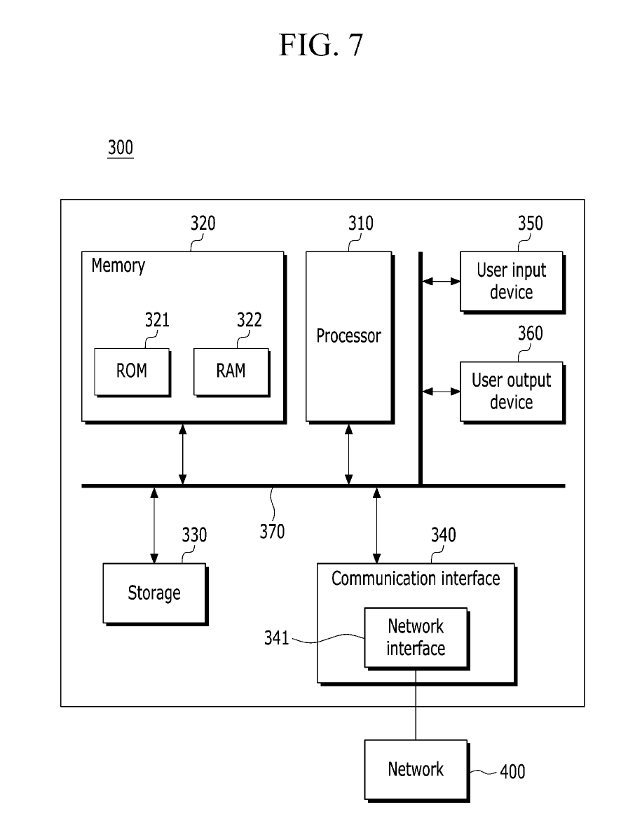

Meanwhile, an embodiment of the present invention may be implemented in a computer system, e.g., as a computer readable medium. As shown in FIG. 7, a computer system 300 may include one or more of a processor 310, a memory 320, and a storage 330. The computer system 300 may further include a communication interface 340. The communication interface 340 may include a network interface 341 that is coupled to a network 400. The computer system 300 may further include a user input device 350 and a user output device 360. Each of elements 310-360 may communicates through a bus 370.

The processor 310 may be a central processing unit (CPU) or a semiconductor device that executes processing instructions stored in the memory 320 and/or the storage 330. The memory 320 and the storage 330 may include various forms of volatile or non-volatile storage media. For example, the memory 320 may include a read-only memory (ROM) 321 and a random access memory (RAM) 322.

Accordingly, an embodiment of the invention may be implemented as a computer implemented method or as a non-transitory computer readable medium with computer executable instructions stored thereon. In an embodiment, when executed by the processor 310, the computer executable instructions may perform a method according to at least one aspect of the invention.

According to an exemplary embodiment of the present invention, a terminal in the D2D communication may randomly select a specific transmission resource in a designated resource pool, and transmit information using the selected transmission resource.

In addition, according to an exemplary embodiment of the present invention, a terminal may randomly select a transmission resource based on sensing. Through this, collisions between transmission resources can be alleviated compared with a case that a terminal randomly selects a transmission resource without sensing.

Additionally, according to an exemplary embodiment of the present invention, a transmission terminal may randomly select a transmission resource based on sensing.

Additionally, according to an exemplary embodiment of the present invention, resources can be successively occupied.

Additionally, according to an exemplary embodiment of the present invention, a SPS type of scheduling, which is appropriate for providing PTT (Push-to-Talk), still image (still picture), and motion picture (dynamic picture or moving picture) service, can be supported.

Additionally, according to an exemplary embodiment of the present invention, a reception terminal is able to recognize the continuous transmission of the SA information even though the reception terminal does not decode the SA information.

Additionally, according to an exemplary embodiment of the present invention, continuous collisions of SA information or D2D data can be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for device-to-device (D2D) communication in which a first terminal directly communicates with another terminal, comprising:
configuring a value of a first field that indicates continuous transmission of scheduling assignment (SA) information as a first value, when trying to transmit the SA information in a second SA resource pool after a first SA resource pool as well as in the first SA resource pool for the SA; and
transmitting the SA information including the first field using a first SA resource included in the first SA resource pool.

2. The method for D2D communication of claim 1, wherein
a first resource region for the D2D communication is divided into the first SA resource pool and a first D2D data resource pool for D2D data transmission, and
a second resource region after the first resource region is divided into the second SA resource pool and a second D2D data resource pool after the first D2D data resource pool.

3. The method for D2D communication of claim 2, further comprising transmitting the SA information by using a second SA resource that is in the same location as the first SA resource among a plurality of SA resources included in the second SA resource pool.

4. The method for D2D communication of claim 2, further comprising configuring the value of the first field as a second value that is different from the first value when trying to complete the transmission of the SA information in the first SA resource pool.

5. The method for D2D communication of claim 2, further comprising
transmitting first D2D data by using a first D2D data resource among a plurality of D2D data resources included in the first D2D data resource pool,
wherein the SA information that is transmitted using the first SA resource further includes:
information of the first D2D data resource;
modulation scheme information of the first D2D data;
coding scheme information of the first D2D data; and
an identifier related to a terminal that is going to receive the first D2D data.

6. The method for D2D communication of claim 2, wherein a number of bits of the first field is one.

7. The method for D2D communication of claim 1, wherein
transmitting the SA information using the first SA resource includes:
monitoring whether the SA information of another terminal is transmitted in the M^{th} (here, M is a natural number of N or less) first SA resource among the N (here, N is a natural number of 2 or more) first SA resources for transmitting the SA information of the first terminal; and
repeatedly transmitting the SA information of the first terminal by using the N first SA resources when the SA information of the another terminal is not transmitted in the M^{th} first SA resource.

8. The method for D2D communication of claim 2, further comprising:
monitoring whether D2D data of another terminal is transmitted in the M^{th} (here, M is a natural number of N or less) first D2D resource among N (here, N is a natural number of 2 or more) first D2D data resources included in the first D2D data resource pool; and
repeatedly transmitting D2D data of the first terminal by using the N first D2D data resources when the D2D data of the another terminal is not transmitted in the M^{th} first D2D data resource.

9. A method for device-to-device (D2D) communication in which a first terminal directly communicates with another terminal, comprising:
monitoring first SA information that is transmitted through a first SA resource pool for Scheduling Assignment (SA);
determining a first SA resource to be reserved among a plurality of SA resources included in a second SA resource pool after the first SA resource pool when a value of a first field included in the first SA information is a first value; and
selecting at least one second SA resource among the rest of the SA resources except for the first SA resource among a plurality of SA resources included in the second SA resource pool.

10. The method for D2D communication of claim 9, wherein
a location of the first SA resource in the second SA resource pool is identical to that of a third SA resource in the first SA resource pool, and
the third SA resource is an SA resource in which the first SA information among a plurality of SA resources included in the first SA resource pool is transmitted.

11. The method for D2D communication of claim 9, further comprising
transmitting second SA information by using the at least one second SA resource, and
the selecting at least one of the second SA resource includes
randomly selecting the at least one second SA resource among the rest of the SA resources except for the first SA resource among a plurality of SA resources included in the second SA resource pool.

12. The method for D2D communication of claim 9, wherein:
a first resource region for the D2D communication is divided into the first SA resource pool and a first D2D data resource pool for D2D data transmission; and
a second resource region for the D2D communication after the first resource region is divided into the second SA resource pool and a second D2D data resource pool after the first D2D data resource pool.

13. The method for D2D communication of claim 12, wherein
the first SA information further includes:
information of a first D2D data resource used for transmitting first D2D data among a plurality of D2D data resources included in the first D2D data resource pool by the terminal that transmits the first SA information;
modulation scheme information of the first D2D data;
coding scheme information of the first D2D data; and
an identifier related to a terminal that is going to receive the first D2D data.

14. The method for D2D communication of claim 9, wherein the first SA information is plural.

15. The method for D2D communication of claim 9, wherein a number of bits of the first field is one.

16. A method for device-to-device (D2D) communication in which a first terminal directly communicates with another terminal, comprising:
determining whether a first transmission probability value is configured for the first terminal only; and
transmitting first information by using the first transmission probability value among the first transmission probability value and a second transmission probability value for a first cell to which the first terminal belongs when the first transmission probability value is configured.

17. The method for D2D communication of claim 16, wherein
the first information is one of Scheduling Assignment (SA) information for the SA and D2D data, and
the first transmission probability value is greater than the second transmission probability value.

18. The method for D2D communication of claim 17, wherein
transmitting the first information using the first transmission probability value comprises:
selecting a first SA resource among a plurality of SA resources included in a SA resource pool for the SA when the first information is the SA information; and
determining whether to transmit the SA information using the first SA resource based on the first transmission probability value,
wherein a resource region for the D2D communication is divided into the SA resource pool and a D2D data resource pool for D2D data transmission.

19. The method for D2D communication of claim 18, further comprising
transmitting the first information using the second transmission probability value when the first transmission probability value is not configured,
wherein the second transmission probability value is commonly applied to all of the terminals that exist in the first cell.

20. The method for D2D communication of claim 16, wherein first transmission probability value is configured by a base station of the first cell.
